(19) United States
(12) Patent Application Publication
(10) Pub. No.: US 2015/0356523 A1
(43) Pub. Date: Dec. 10, 2015

(54) DECENTRALIZED IDENTITY VERIFICATION SYSTEMS AND METHODS

(71) Applicant: ChainID LLC, Denver, CO (US)

(72) Inventor: William Evan Madden, Denver, CO (US)

(21) Appl. No.: 14/298,906

(22) Filed: Jun. 7, 2014

(51) Int. Cl. G06Q 20/06; G06Q 20/38; H04L 9/32

(52) U.S. Cl. CPC G06Q 20/065; H04L 9/3247; H04L 9/3236; G06Q 20/38215; G06Q 2220/00

(57) ABSTRACT

The present invention involves systems and methods that allow participants in cryptocurrency networks to exchange cryptocurrency for traditional currency legally and safely without requiring the use of a traditional exchange or online brokerage as a fiduciary. The invention accomplishes this through the use of a decentralized identity verification protocol that allows a service provider to verify the identity of a participant and then publish an identity signature on the participant's cryptocurrency address or addresses. The invention enables full compliance with Country specific customer identification program and anti-money laundering requirements, and maintains the ability to independently satisfy requests for information or data retention requirements if requested by legally authorized parties, but does not require that the participant store the private keys or access controls to their cryptocurrency on an exchange or brokerage service.

The invention serves to verify a participant's identity in full compliance with US Bank Secrecy and Patriot Act provisions or similar regulations where identification may be achieved through non-documentary or documentary identity verification procedures. After passing the applicable verification procedure, the service provider stamps the participant's cryptocurrency address with a transaction containing an identity signature. This identity signature within the transaction consists of a public indicator of the participant's Country and subdivision, a compliance level code, an ID type indicator, and an identity hash. The identity hash is created from the digests of cryptographic hash functions where the participant's personal information is used as an input. The service provider signs the transaction with their authorized private key that corresponds to their publicly accessible public key. This serves as a publicly verifiable confirmation that the identity associated with the address in question was validated by the service provider authorized to act on behalf of the regulatory authority.

The participant may then purchase and sell cryptographic currency from and to a third party exchange or brokerage service legally and safely when using their verified cryptocurrency address. This is because the third party is able to confirm compliance by openly referencing and verifying the identity verification transaction present on the address. Subsequent transactions where the third party sells or purchases cryptocurrency for the verified participant are similarly stamped with a transaction conforming to the identity verification protocol. This allows the third party interacting with the verified participant's address to observe any regulations limiting the amount or frequency of transactions over a variable period of time. It follows that this address could be used with any third party or participant in the cryptocurrency network that observes the decentralized identity verification protocol, all without requiring the third party or participant to collect and verify personal information redundantly. The ability to verify an identity remotely also eliminates the need for the third party to act as a fiduciary holding the private keys or access controls to the verified address. Lawful requests for information by authorized authorities are served to the service provider as digitally signed transactions that may then be linked to the participant's identity and transactions, allowing the protocol to observe subpoenas or similar lawful requests for information. The encrypted personal information may be held in escrow by the service provider indexed to the verified cryptocurrency address for such purposes. An alternate embodiment would store the encrypted personal information in a decentralized network of other participants, with the information accessible for retrieval using the public key of the verified cryptocurrency address and decryption using the corresponding private key, decentralizing the process entirely except for the identity verification step.

### BACKGROUND OF THE INVENTION

Regulation in the United States requires banks, savings associations, casinos, credit unions, and money service businesses to comply with anti-money laundering programs, including customer identification programs (CIP). CIP requires businesses to collect personal information about all of their customers. For a US citizen, this personal information must include: name, date of birth for an individual, residential or business street address, taxpayer identification number. CIP also requires businesses to perform documentary or non-documentary identity verification procedures on this personal information. Due to higher speed and lower cost, businesses most commonly conduct non-documentary identity verification procedures where a comparison is made between the personal information and records obtained from consumer reporting agencies, public databases, or other sources. Similar regulations exist in other Countries and regions, leading to an exponentially more complicated regulatory landscape for international transactions.

These requirements necessitate that businesses collect and maintain databases of personal information, but also create demand for third party identity verification processors, credit reporting agencies and other businesses that specialize in these activities. Personal information is also subsequently sold to data brokers, who further sell the data to other entities. Transacting with a financial product online or at retail also creates a transference of personal information, as credit card numbers, names, addresses, and security codes are used to validate transactions over the major payment networks. This creates an exponential increase in systemic risk where an individual's personal information is stored redundantly with hundreds or thousands of separate databases and companies, creating a massive attack surface for hackers and organized criminals. If any one of these entities experiences a data breach due to a technology or process vulnerability when collecting, storing, transmitting, or processing data, millions of individual identities are subject to theft. Hundreds of millions of US citizens have now been victimized by these breaches. A recent breach compromised over one-hundred million identities in a single event, and many have been victimized multiple times. Each compromise results in the identities being sold openly to the highest bidder on anonymous deep web ecommerce sites, or in closed black markets. Because the same personal information traditionally used to validate a citizen's identity is also used to authorize financial transactions, the theft of either creates a wave of additional frauds with ecommerce, banking, and tax refund processing, as purchased identities are monetized in the existing system for profit. The issue is equally as pervasive in other developed Countries, who have modeled their regulatory regimes on that of the United States.

While data breaches are a serious risk for online banks and their vendor companies, they are catastrophic events for businesses that wish to offer cryptocurrency services. While online cryptocurrency services look and feel just like an online bank, the currency they deal in is subject to immediate, untraceable, and irreversible theft. While traditional currencies are associated with individuals or businesses in electronic format and can easily be reversed or tracked, cryptocurrencies behave more like a digitized precious metal or unmarked cash currency. When it is stolen there is little to no chance of retrieving your funds, or apprehending the party responsible.

When businesses offer services that aggregate cryptographic currency in large amounts, they become targets for both organized crime rings, unscrupulous employees who may work for organized crime rings, or hackers outside of the business entirely. Breaking in can pay off hundreds of millions of US dollars at today's exchange rates, with little to no risk of being caught. The proportion of the businesses' balance of cryptographic currency scales in direct proportion to how lucrative they are as a target for theft. The risks of theft are catastrophic for businesses and their account holders, and the costs of securing and insuring the cryptocurrency from theft are high. This invention obviates the need for this level of security by allowing participants to retain control of their cryptocurrency yet enables the participant to comply with regulation, clearing the way for a safer, less expensive, and entirely new hybrid decentralized exchange business model.

### BRIEF SUMMARY OF THE INVENTION

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

The specific personal information elements and cryptographic hash function(s) suggested for use for verification, matching, revocation and expiration are outlined in the brief summary and detailed description sections below, however the invention is not meant to be specific to these elements and functions or limited by their mention. The invention is conceived to work with alternate elements and functions and transcends these details so as to be extended globally, as documented in the claims portion of the application. Specifically, the definition, length, and consistency of ISO codes, compliance level codes, ID type indicator, or the construction, length, or definition of the identity hash, including the cryptographic hash function(s) or other processes used in its creation should not limit or constrain the claims of the invention, as regulations constantly change globally, and cryptographic hash functions reach obsolescence and new, more secure functions replace them. Furthermore, the claims of the invention should not be considered constrained or limited by the rules of the cryptocurrency protocol used for an implementation, as identity signatures could be components of addresses, transactions sent to or from addresses, the specific inputs and outputs associated with transactions, or scripts within inputs or outputs that may contain or refer to identity signature records depending on the technology of the underlying cryptocurrency protocol. Herein this application will use the bitcoin protocol version 0.9.1 and US Country regulation to describe the invention and aid in its demonstration, but these implementation details should not limit the claims of the invention.

The participant sends required personal information through a plurality of channels, including but not limited to visiting a web page, calling an interactive voice response unit or customer service telephone number, or sending information physically by mail. The participant may provide their own cryptocurrency address or a plurality of addresses, or request an address or plurality of addresses if desired. In one embodiment of the invention, the participant also enters a passphrase or biometric identifier along with the cryptocurrency address and personal information.

The service provider first determines an identity signature value for the participant based on provided information. This signature consists of an ISO code corresponding to the participant's Country and subdivision, a compliance level code corresponding to the level of identity verification performed, an ID type indicator that reveals the type of ID that was used to verify the participant's identity, and an identity hash, which is the cryptographic output or digest of elements of a plurality of elements within the participant's personal information. The identity hash and ISO code portions of the identity signature may be used by the service provider to confirm the information provided does not match an existing identity signature for the participant's Country and subdivision in the decentralized cryptocurrency ledger. This is possible because the elements used to create the identity hash are unique to a participant in a given Country. In the event of a matching hash and Country, the service provider will check for the presence of a digitally signed revocation transaction with the same hash and Country, or if the transaction has expired by comparing its timestamp of the identity signature transaction with the time of the comparison. If the transaction with the matching hash has a valid signature, has not been revoked, and is not expired, the request is rejected as invalid as a duplicate request. In another embodiment of the invention particular to a specific Country, only an identity hash is required, as created from a plurality of personal information elements, verified or unverified. In another embodiment of the invention, the identity hash is generated using an international identity number as an input, allowing for a globally unique identity hash and or signature.

After the service provider verifies that the hashed digest of the specific elements in the participant's information does not match a previously existing transaction, or if a match exists, that the transaction has been revoked or is expired, the service provider may or may not perform specific identity verification procedures as required by applicable regulation. In one embodiment of the invention, a documentary identity verification procedure is required, where the participant share physical documents containing their identity by post, transmit facsimiles of images, or upload images of such documentation to the service provider. In another embodiment of the invention, a non-documentary identity verification procedure is performed, where data provided by the participant is compared against data in public records or other sources, and assuming a sufficient degree of consistency between records, is considered verified. In yet another embodiment of the invention, no identity verification procedure is required.

Assuming successful identity verification if required in the embodiment, the service provider stamps the participant's cryptocurrency address or plurality of addresses with a transaction or plurality of transactions. This transaction or plurality of transactions includes an identity signature and is digitally signed with a private key possessed by the service provider, proving authenticity. The public key corresponding to this private key is available publicly for third parties to access and use to verify the authenticity of the service provider's digital signature and may be included for reference in the transaction or plurality of transactions, depending on the underlying cryptocurrency protocol used. The contents of the identity signature will be documented in the detailed description section.

This process uniquely identifies a cryptocurrency network participant in a manner congruent with processes required by banks or money service businesses. In one embodiment, the participant's personal information may be archived by the service provider in order to meet applicable rules around data retention following a customer identification event. In another embodiment, the participant's personal information may be encrypted with the service provider's keys, and stored in a decentralized storage network hosted by other participants. All embodiments authorize the participant to transact and exchange crypto or traditional currency as a known customer, regardless of whether the customer has an account, as the verified identity signature is available for reference and verification in a decentralized public database, and the corresponding personal information may be retrieved with a lawful order from the archived database of the service provider, or with authorizing events retrieved and decrypted from the decentralized storage network.

The participant may then purchase or exchange cryptocurrency and alternate currencies using traditional financial instruments as allowed by applicable regulation and law, including but not limited to: alternate cryptocurrencies, non-cryptographic virtual/digital currencies or e-currencies, credit card instruments, debit card instruments, prepaid card instruments, EMV/CHIP enabled card instruments, federated payment systems such as ACH, BACS or Faster Payments, IBAN, SWIFT, Instant ACH, other bank wires, money orders, personal checks, or cashier's checks. Furthermore, the participant may conduct other activities that legally require a verified identity freely, without requiring redundant identity verification processes, sharing of sensitive personal information or cryptocurrency private keys with additional entities.

In another embodiment of the invention, law may require limits on the amount or number of transactions a participant may conduct in a specific timeframe. In this embodiment, entities with which the verified participant transacts may stamp transactions with a variation of this compliance level code to the fixed and verified cryptocurrency address, allowing aggregate principal or transaction counts. Entities transacting directly with the participant's fixed verified address may stamp the transactions directly with a variation of the compliance level code.

In another embodiment, entities may transact with the participant indirectly using a verified cryptocurrency routing or stealth address. Here the transaction between the participant and entity remains private as the destination address are derived with a shared secret. The entity may observe regulation by sending a subsequent transaction to the verified cryptocurrency routing or stealth address with the count or principal amounts but without the transaction details.

In another embodiment the participant may require a plurality of fixed verified cryptocurrency addresses, and the service provider may send a plurality of digitally signed transactions to more than one fixed or stealth address, associating many cryptocurrency addresses with a single verified identity for a participant.

In the event that the participant forgets or loses control over their verified cryptocurrency address or plurality of verified addresses, or upon granting power of attorney or upon participant death, the service provider may send a digitally signed revocation transaction or a plurality of transactions as required, severing the participant's identity from the cryptocurrency address or plurality of addresses. The participant, heirs, estate attorney, or other interested prty may need to repeat a documentary or non-documentary identity verification procedure or provide a certificate of death in order to initiate the revocation process.

In one embodiment of the invention, the identity verification procedure may expire after a period of time as determined by law. In this embodiment, the timestamp associated with the original transaction or plurality of transactions containing the identity signature may be used to calculate the expiry period of the identity verification. In another embodiment of the invention, multiple private key digital signatures are required by a service provider or sovereign authority in order to authorize an exchange transaction or plurality of transactions, in addition to the initiating participant and or recipient. In yet another embodiment, multiple private key digital signatures are required by a service provider or sovereign authority in order to serve a subpoena or similar lawful order for transaction, plurality of transactions, and or corresponding personal information details.

### BRIEF DESCRIPTION OF THE DRAWINGS

Illustrative embodiments of the present invention are described in detail below with reference to the following drawing figures.

FIG. 1 is a high level diagram of the decentralized identity verification process.

FIG. 2 is the information collection, duplicate, revocation and expiry verification process.

FIG. 3 shows the documentary and non-documentary identity verification procedures and digitally signed compliance level code transaction process on a fixed cryptocurrency address or addresses.

FIG. 4 is a variation showing a stealth or routing address verification and transaction process.

FIG. 5 shows a transaction to a verified participant using a fixed verified cryptocurrency address and the corresponding variation of the compliance level code for velocity or aggregate principal regulation compliance.

FIG. 6 shows the revocation process.

FIG. 7 shows the multiple signature identity authorization process.

FIG. 8 represents the subpoena or lawful request for information process.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As used herein, the term “cryptocurrency address” is a logical address in a cryptocurrency protocol, typically an encoded output of a cryptographic hash function using the public key as the input, or as a digital currency public key in raw or encoded format. The term “cryptocurrency address” may be used interchangeably with the public key or cryptocurrency address derived from the public key, or any raw or encoded versions of either the public key or cryptocurrency address.

The term “cryptocurrency network” refers to any decentralized system using a proof of work, proof of stake, or similar decision making methodology in order to determine consensus between participants in a decentralized network, with or without integrated economic incentives to provide computing power in order to run the decision making and consensus system.

The term “ledger” refers to a decentralized ledger of information that is shared between participants in a cryptocurrency or other decentralized network. The term “ledger” may be used interchangeably with “cryptocurrency ledger”, “public ledger”, “decentralized cryptocurrency ledger” or “decentralized ledger”.

The term “participant” refers to any individual, business, or other entity that participates in a cryptocurrency network. The term “participant” may be used interchangeably with “network participant”.

The term “service provider” refers to any entity authorized by regulatory authorities to perform participant identification verification activities, or refers to an entity contracted by the authorized entity to perform such activities on its behalf, as allowed by applicable regulation.

The term “third party” refers to any brokerage, exchange, or other entity with which a participant intends to engage in regulated activities, such as the exchange of cryptocurrency for traditional currency, or vice versa.

The term “transaction” refers to a cryptocurrency transaction sent to or from a cryptocurrency address inside a cryptocurrency protocol. The term “transaction” may be used interchangeably with inputs and or outputs that form a transaction, a plurality of such inputs and or outputs, and scripts within the transaction, and or a plurality of such scripts.

The term “digest” refers to the output of a cryptographic hash function, and may be used interchangeably with the term “hash” or “output”.

The term “identity signature” refers to a concatenation of information used to identify a verified network participant, including a geographic indicator, a compliance level code, an ID type indicator or identification type indicator, and an identity hash. In another embodiment, the term “identity signature” may refer to just an identity hash alone, or the identity hash and a subset of the plurality of elements used to form the concatenation defined above.

The term “identity hash” refers to the digest of a cryptographic hash function or plurality of hash functions used alone or in combination with a participant personal information element or a plurality of elements as the input to the function or plurality of functions.

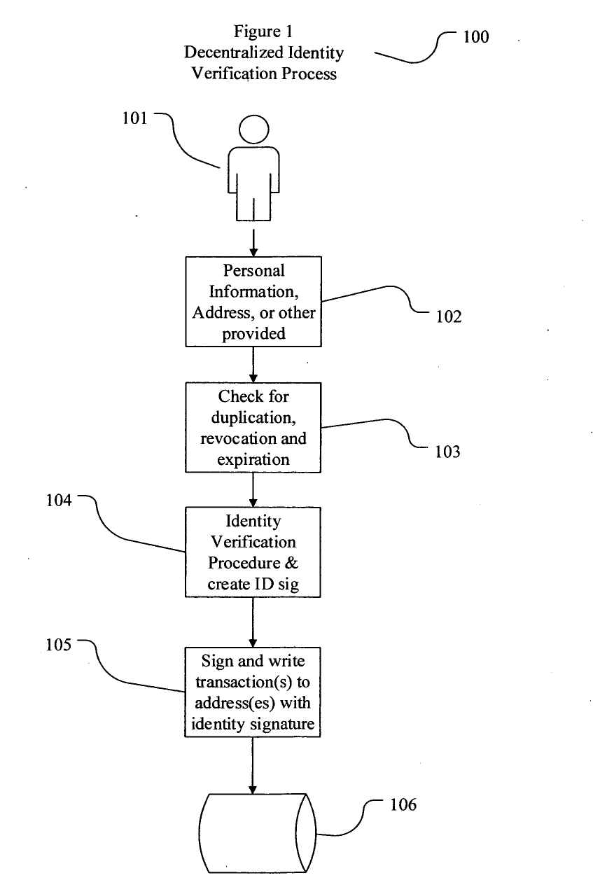

FIG. 1 showing decentralized identity verification process 100 is detailed further in later diagrams and is meant to show a high level view of the verification process. Participant 101 is required to supply personal, address and other information 102 according to the superset of the participant's desired level of verification, the processes and procedures of the service provider, the amount and nature of transactions they wish to perform, and applicable regulation in order to meet regulatory standards. Process 100 also includes the duplication, revocation and expiry check process 103 where the participant identity signature is created from a precisely formatted concatenation of participant Country and subdivision, compliance level code, ID type indicator, and an identity hash generated from elements of personal information 102 using cryptographic hash function(s). In another embodiment of the invention, the identity signature may contain only an identity hash, or a subset of the plurality of elements in the concatenation of the identity signature defined above, depending on the requirements of the region and implementation. Identity verification procedure and create identity signature 104 occurs next where personal information may be verified against public information or other sources by the service provider or vendor, or reviewed more manually for documentary processes and assuming successful verification, and an identity signature is generated from a verified element or plurality of elements from personal information 102, and other components of the identity signature concatenation as required by the embodiment of the invention. The identity signature is written to the cryptocurrency address or plurality of addresses the participant desires to verify for regulatory compliance. This identity signature is recorded to the cryptocurrency address in a delivery mechanism consisting of a transaction, a plurality of transactions, an input, output, or script, a plurality of inputs, outputs, or scripts within a transaction in 105, and the previously defined delivery mechanism hosting the identity signature is confirmed by the network and entered into decentralized cryptocurrency ledger 106 for future reference. The identity signature is as unique to the participant as the identification type used to generate the hash, and may be unique on a subdivision, Country, or global level depending on the type of identification used to generate the identity hash and identity signature. In all embodiments of the invention the verified personal information is computationally impractical to reverse from the hash digests of the cryptographic hash function or plurality of hash functions that used the verified personal information as an input or plurality of inputs.

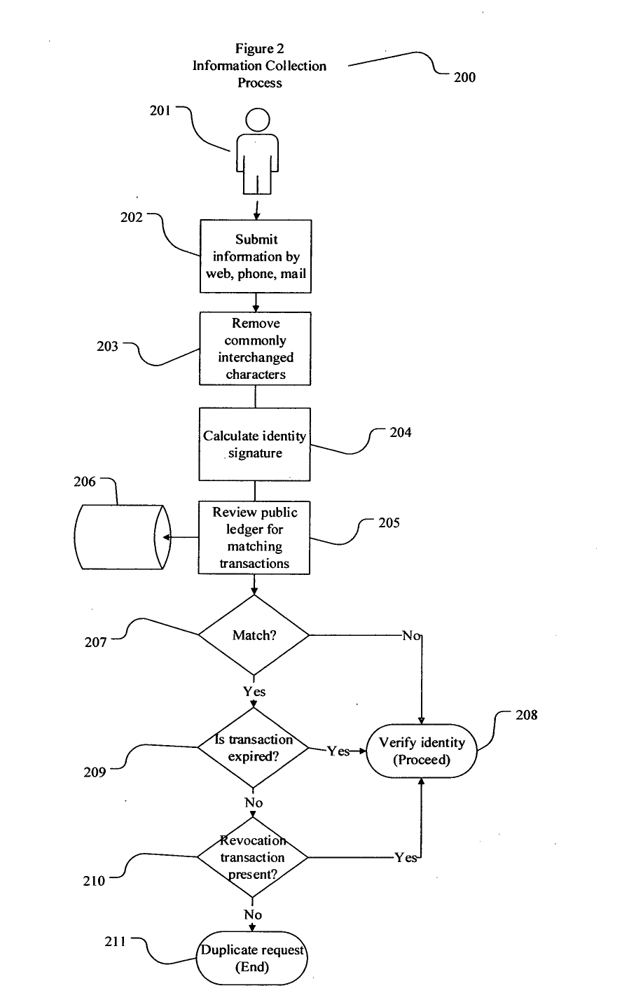

FIG. 2 shows information collection process 200 where participant 201 provides required personal information found in 102 to the service provider by a plurality of channels including but not limited to web, mobile web, telephone interactive voice response unit or customer service representative, facsimile, or post office in step 202. Step 202 may include input validations to ensure that data is formatted properly as possible based on the limitations of the channel through which the data was provided. The necessary level of compliance, allowable ID type indicators, and geography of the participant at a Country and subdivision level must be defined in 202 as well. While not a specific claim of the invention, information collection process 200 includes optional step 203 where the service provider may revise the personal information 102 provided in step 202 by removing commonly interchanged characters, applying a standard case sensitivity, or otherwise encoding the data so as to improve its uniqueness, human or machine readability and accuracy. Calculate identity signature 204 repeats in more detail 102, and includes setting of the geographic Country and subdivision of the participant, the compliance level code as required by the participant's intended verification level and regulatory authority requirements, and an ID type indicator. An element or plurality of elements from the personal information provided in 202 and optionally encoded in 203 are used as inputs to a cryptographic hash function or plurality of functions in order to generate an identity hash, which may be unique to the participant depending on elements used as inputs. In one embodiment, additional user, service provider, or third party supplied data may be used as inputs to the function or plurality of functions. In another embodiment, data may be introduced to the inputs as salt. The geographic indicator, compliance level code, ID type indicator, and identity hash are concatenated in 204 and form the identity signature. In another embodiment of the invention, a subset of the identity signature above is generated, and may consist of just the identity hash alone, or the identity hash and a combination of a subset of elements defined above.

In order to clarify the invention, below is a specific example implementation of the invention using a United States specific example under the bitcoin cryptocurrency protocol as of version 0.9.1. This detailed description will not specify the anatomy of bitcoin transaction inputs, outputs and scripts in great detail as this information is publicly available and not a claim of this invention. Instead the focus will be on the claims of the invention, the validation of an identity verification transaction through a digital signature from a service provider and an identity signature derived from the Country, subdivision, compliance level code, ID type indicator, and identity hash respectively.

In one embodiment of the invention, the ID verification transaction may contain an OP_CHECKSIG input that requires the transmitting participant, in this case the ID verification service provider, to include their public key and a digital signature from the private key matching this public key in order to certify the authenticity of the transaction. In another embodiment, the ID verification transaction may be sent from the participant to the ID verification service provider. Here the ID verification service provider may sign an output of the transaction containing an OP_RETURN output as they spend it as an input to another address, and in doing so certifying the authenticity of the identity signature inside, while simultaneously automating settlement as another output of the transaction in predefined amounts sufficient to compensate the provider for services rendered in one automated process.

In this implementation the identity signature is contained in an output called OP_RETURN that allows for up to 40 bytes of data. The first four bytes in positions one through four of the OP_RETURN output indicate the geography of the participant Country and State or Province as defined by 4 byte ISO 3166-2 alpha-2 country code with subdivision. The next two bytes in positions five and six indicate the compliance level of the verification event. These two bytes will vary by Country Subdivision combination but for the United States may initially contain four levels, with many levels reserved for later definition as required. Code 01 may corresponds to an anonymous verification event where the identity hash is ignored and no data is input to hash functions. Code 02 may correspond to minimal verification and is not to be considered unique or revocable, but indicates that an OFAC check or other non-unique matching was performed at the time of verification, should data be required by a lawful order to the service provider. Code 03 may correspond to identification meeting requirements for a money transfer from a US state without special requirements of between $1000 and $2999.99 or verification sufficient to open most current accounts. Code 03 may indicate a unique identity hash that is revocable, that OFAC checks were performed, and that a documentary or non-documentary identity verification procedure was completed successfully. Because Code 03 may be unique and revocable, the required ID type indicator for Code 03 may need to conform to an SSN/ITIN/EIN/TAXID number issued at a national level, so as to guarantee uniqueness and consistency of the identity hash. Code 04 may indicate a high level of verification as required for money transfers of $3,000 or above where two forms of identification were collected and validated, using national level ID for the unique identity hash, as with Code 03. The next two bytes in positions seven and eight indicate an ID type indicator, denoting the type or types of identification used in the verification procedure as required by compliance level codes three and four in this description. ID type indicator 01 may correspond to national ID such as SSN/ITIN/EIN/TAXID for the Country of US. ID type indicator 01 may be required as the sole form of ID that allows for uniqueness of a participant. The remaining tens of thousands of ID type indicators can be reserved for a plurality of other or subdivision specific ID types that are not unique or ubiquitous within a specific Country.

The anatomy for an example raw bitcoin transaction containing an OP_RETURN identity hash output is defined here and illustrates one embodiment of the identity signature that contains the ISO code geography, compliance level code, ID type indicator, and Identity Hash components. The transaction itself and OP_RETURN output is not a claim of the invention and should not constrain the scope of the invention, where the identity signature contained in the output of the example is an implementation of the invention and will vary across cryptocurrency networks and in new versions of the bitcoin protocol specifically outlined in this example:

########$$****************************************************************&&& &&&&&^{̂̂}@@@@@@@@XX++++++++++++++++YYOOHH111122334444444444444444444444444444444444444444TTTTTTTT

Identity signature bolded and italicized for emphasis 1, 2, 3 and 4 (up to 40 bytes matching length indicated by H) in OP_RETURN conforming to:

111122334444444444444444444444444444444444444444

Where 1 is the 4 byte ISO 3166-2 alpha-2 country code with subdivision, 2 is the two byte compliance level code, 3 is the two byte ID type indicator, and 4 is the identity hash as the final output of the SHA256 and RIPEMD160 cryptographic hash functions in 204 “A” through “D”, base64 encoded as “E”. Any unused bytes in 4 are left null before the final 8 byte lock time T.

Below follows a detailed use case for a US participant living in the subdivision of Georgia for compliance level code 03 using ID type indicator 01 as calculated with the following steps.
1. First, it is determined that the participant lives in Georgia in the United States and must conform to a compliance level code 03, requiring an identity verification procedure with both date of birth and valid National ID in the SSN/ITIN/EIN/TAXID category corresponding to ID type indicator 01, along with other data elements to be used in a non-documentary identity verification procedure that will not be input to generate the identity hash. This results in first eight bytes of the identity signature as: USGA0301 for US, Georgia, Code 03, ID type indicator 01.
2. Second the full identification number as indicated by the compliance level code, in this case SSN is used as an input to a SHA256 hash function. The input must have no special characters or separators and consist of the identification number alone, and match exactly the data used for documentary or non-documentary identification processes. This nine digit input results in a 32 byte digest “A”.
3. Third, the participant date of birth is formatted as yyyymmdd also without special characters or separators and as used for identification processes is used as an input to a second SHA256 hash function, resulting in a 32 byte digest “B”.
4. Fourth, the output “A” is prepended to output “B”, resulting in a 64 byte string “C”.
5. Fifth, the 64 byte string “C” is used as an input to a RIPEMD160 cryptographic hash function resulting in a 160 bit output “D”.
6. Sixth, 160 bit output “D” is base64 encoded, typically occupying a length of 27 bytes as
7. Finally, “E” fills positions 9 through 36 in the OP_RETURN output and any unused characters may be left null or filled with padding to position 40 if desired.
8. Finally, the resulting identity signature consisting of the ISO Country and subdivision, compliance level code, ID type indicator, and identity hash would appear as follows, where # characters represent the unique identity hash as “E”:

### USGA0301########################################

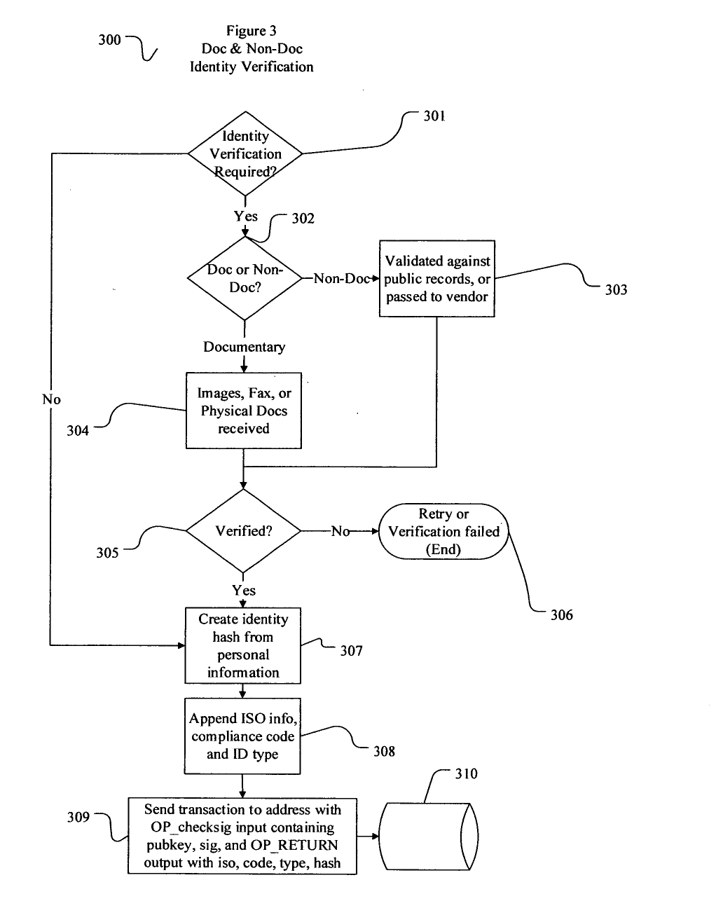

This concludes calculate identity signature 204. In 205 the service provider reviews the public ledger for the cryptocurrency network 206 for a transaction or plurality of transactions containing an output containing the identity signature value matching the value “E” in 204. In other embodiments the identity signature may contain a subset of the components in this example, or consist of just the identity hash alone. The service provider compares “E” to transactions in the ledger in 207, and if no matching identity signatures are found, the process may proceed to 208 and FIG. 3. If the service provider locates a specific cryptocurrency address or a plurality of addresses with a transaction or plurality of transactions listing an identity signature that matches “E”, the provider may compare the timestamp of the matching transaction or plurality of transactions to the present time in 209 to see if the original transaction or plurality of transactions have expired. If the transaction has expired, the service provider may move to 208 and FIG. 3. If the transaction has not expired, the service provider reviews that specific address or plurality of addresses for a revocation transaction or plurality of revocation transactions that occurred after the timestamp of the matching transaction or plurality of transactions in 210. Revocation transactions are formatted in the same manner as identity signature outputs, except for the compliance level code, which will be fixed to a value that is reserved for revocation of identity signatures. If a revocation transaction with a revocation signature corresponding to an identity signature is present on the address or plurality of addresses and was added after the matching transaction or plurality of transactions, the service provider may move to 208 and FIG. 3. If not, the request is flagged as a duplicate identity, denied, and the process ends in 211. It should be noted that in another embodiment of the invention, the participant may authorize the service provider to add additional cryptocurrency addresses and the service provider may send a transaction to these addresses containing the identity signature.

FIG. 3 details the documentary and non-documentary identity verification process 300. A determination is made in 301 regarding if an identity verification procedure is required. If required, a determination is made in 302 as to whether the procedure should be documentary or non-documentary: 303 shows the non-documentary procedure where a plurality of personal information received in 102, 202, and encoded in 203 is compared against public and or other records, or passed to a vendor for comparison. 304 describes the documentary process, where images, facsimiles, or physical documentation is reviewed and an assessment is made as to whether the participant should be verified according to applicable regulation. A decision to verify or deny verification is made in 305. If denied, 306 describes the end of the process or that a retry may be allowed depending on law or service provider procedure. In 307 the identity hash is created from personal information elements received in 102, 202, encoded in 203, and verified in 305. 308 is an optional step depending on embodiment where the identity hash created in 307 is concatenated or otherwise combined with the ISO Country and subdivision of the participant, the compliance level code, and ID type indicator, or a subset of these three elements to create the identity signature. If 308 is not required and none of these three elements are added, the identity hash in 307 is the identity signature in 308. In 309 the identity signature is transmitted to the cryptocurrency address or plurality of addresses intended for verification as part of a transaction, and after confirmation by the cryptocurrency network, the transaction is recorded to the cryptocurrency address or plurality of addresses in 310.

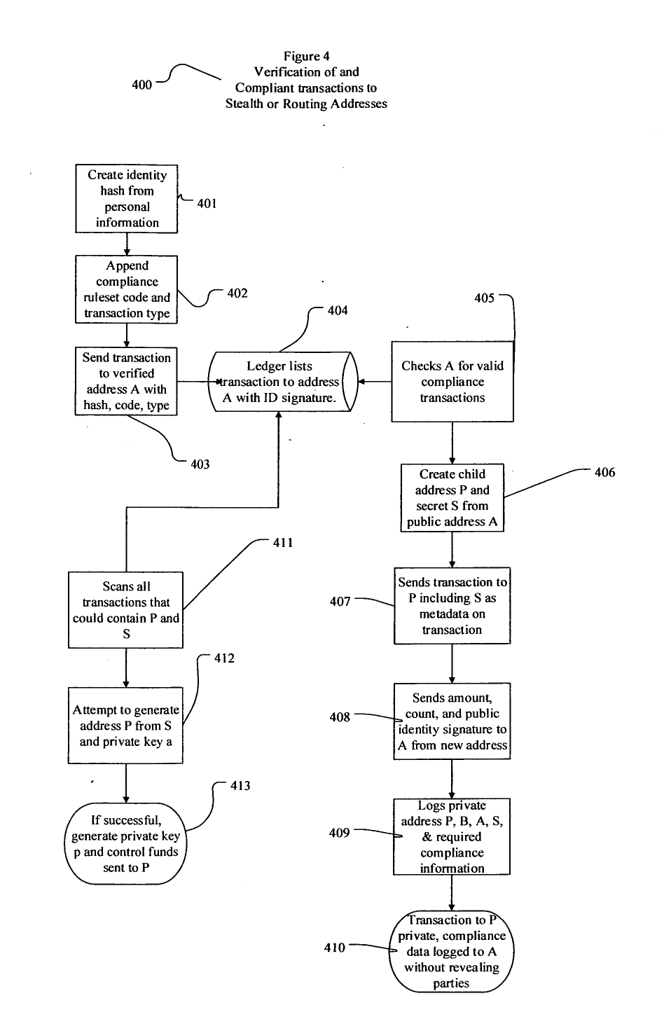

FIG. 4 illustrates the identity verification process as applied to a stealth or routing address in a cryptocurrency network. 401, 402, 403, and 404 duplicate 307, 308, 309, and 310. Stealth address A will be controlled by private key a, controlled by verified participant Y in 310. In 405 another participant X that wishes to transact with the verified participant Y checks the decentralized cryptocurrency ledger for transactions containing the identity signature of verified participant Y by viewing the identity verification transaction or plurality of transactions already present on the address from step 404. Participant X may also confirm that no velocity or aggregate transaction amount regulations have been exceeded in a defined period of time by reviewing transactions on the address with a matching identity signature from 404. In 406, participant X creates a private child address P from A and a secret S used to create P from A. In 407 participant X sends a transaction to new cryptocurrency address P, where the transaction includes metadata containing secret S. In 408 participant X then sends another transaction directly to stealth address A from a different originating address containing the amount, count, and identity signature metadata of verified participant Y, allowing velocity and aggregate transaction limits over defined periods of time to be observed in subsequent transactions, without revealing the details of the private transaction in 407. Participant X logs the private address P, secret S, stealth address A, and any required regulatory details around the transaction in 409. In 410, the process ends for participant X. In 412 verified participant Y scans the decentralized cryptocurrency ledger for all transactions of the type that contain data similar to P and S. In 412 verified participant Y uses private key a and secret S to attempt to calculate address P for every eligible transaction in the ledger. If address P can be calculated from a and S, verified participant Y in 413 may derive private key p and control the funds sent to child address P. In another embodiment of the invention, Participant X may send verified participant Y the secret S directly through secure channels, eliminating the need to calculate whether control of a potential transaction sent to an address with a metadata secret is possible. Both implementations of stealth or routing addresses may be used seamlessly with the invention, or future new implementations may be used with no impact, as regulatory and identity verification information is stored and logged at the stealth address A, which is publicly shared with other participants and is not subject to the exchange of secrets or hidden in unlinked transactions.

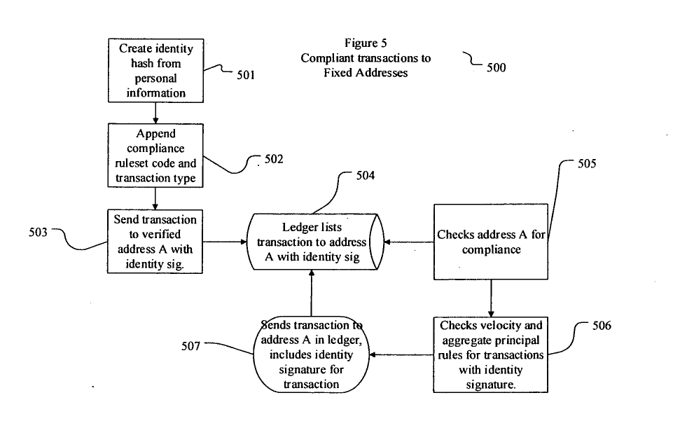

FIG. 5 illustrates compliant transactions to fixed addresses process 500 where participants may send compliant transactions to fixed cryptocurrency addresses. 501, 502, 503, and 504 duplicate 307, 308, 309, and 310. 505 and 506, duplicate 406, where participant X checks for identity signatures of verified participant Y and may check for limits around velocities or aggregate amounts of principal in a period of time. In 507 participant X sends a transaction directly to verified participant Y's address A, including verified participant Y's identity signature in the transaction in order to allow future transactions to obey any rules limiting the count or amount of aggregate transactions in a predefined period of time, as required by regulation. The transaction is committed back to decentralized cryptocurrency ledger 504.

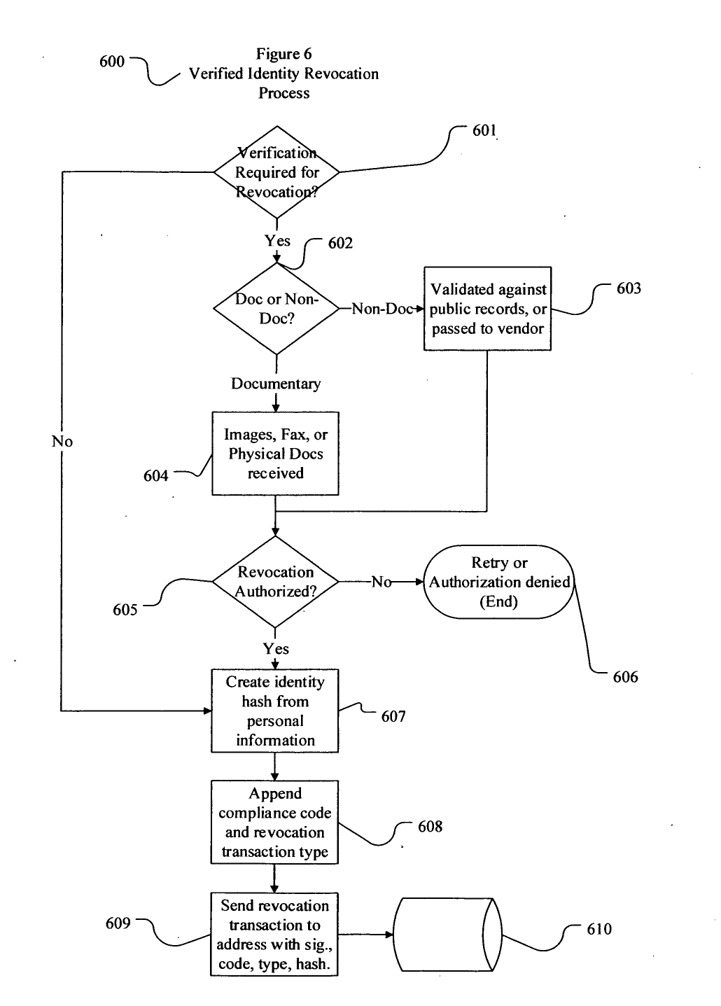

FIG. 6 shows the verified identity revocation process where a determination is made in 601 if verification is required for revocation. If verification is required, 602 determines if it is a documentary or non-documentary process, with 603 and 604 showing the non-documentary and documentary processes respectively, as before in 303 and 304. In 605 a determination is made to allow revocation. 606 denotes a denied authorization or retry in the event of denied authorization and effectively ends the process. 607, 608, 609 and 610 duplicate 307, 308, 309 and 310 where an identity hash is created in 607, an identity signature is created in 608, the identity signature is sent with a transaction or plurality of addresses in 309, and the revocation transaction or plurality of transactions are stored in the decentralized cryptocurrency ledger in 610. The revocation transaction with identity signature is identical to a verifying transaction in this example, except for the compliance level code indicates revocation not a level of compliance verification.

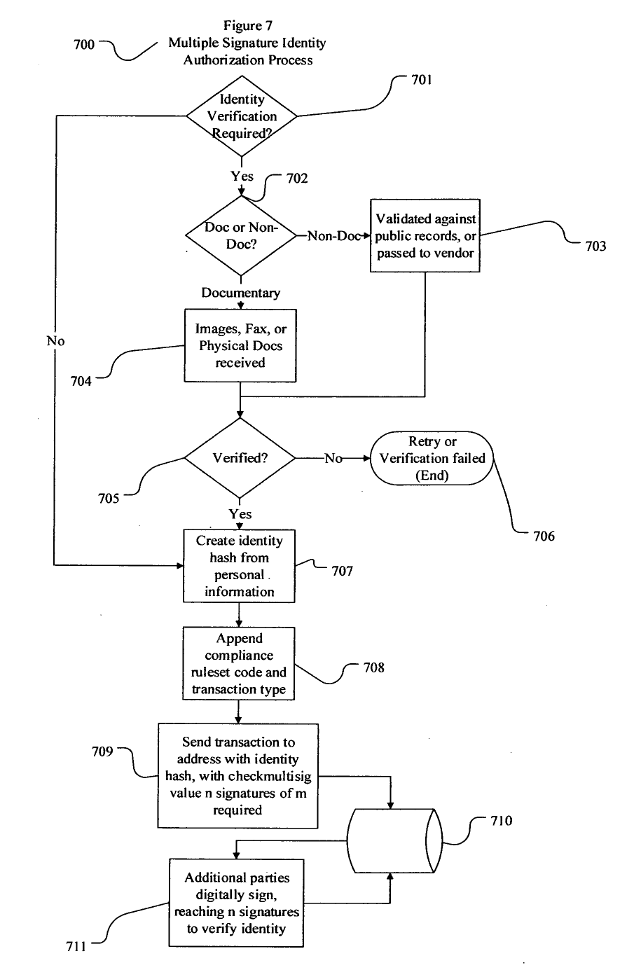

FIG. 7 shows the multiple signature identity authorization process, which is a duplicate of FIG. 3 until step 709 where the transaction is sent to the address. In 709 the transaction containing the identity signature is defined to require multiple signature for validation, and is passed to the ledger in 710 and to the additional parties in 711 until the required number of signatures corresponding to the public keys included in the transaction are found on the transaction, indicating its authorization.

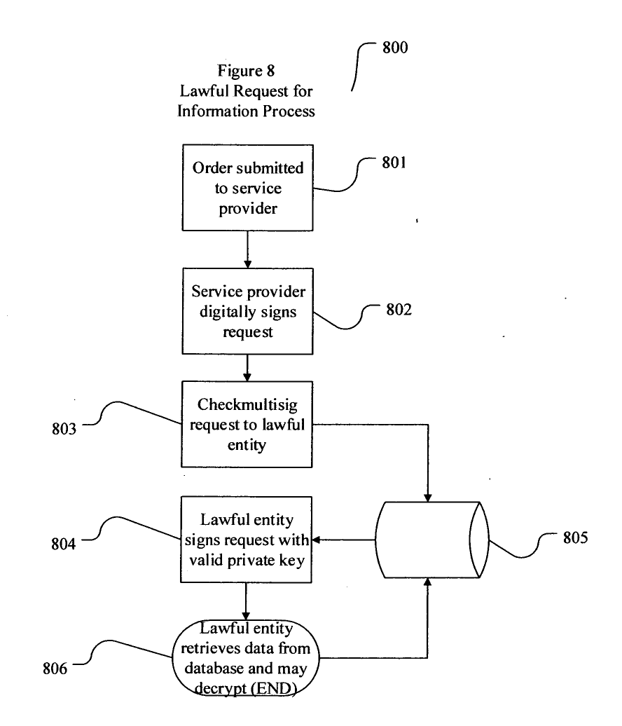

FIG. 8 illustrates a lawful request for information process 800 where an order or subpoena is submitted to the service provider in 801. In one embodiment, the service provider validates the authenticity of the request using traditional methods in 802. In another embodiment, the service provider digitally signs a transaction for the request and includes the public key of the lawful entity requesting the information. The transaction includes instructions that the lawful entity must sign the transaction with their private key in order to complete the request in 803. The lawful entity receives the request in 804 and signs with their private key to the decentralized ledger in 805. In both embodiments the service provider provides the lawful entity with the data in 806. In one embodiment the service provider may store this data in a centrally or cloud hosted database. In another embodiment the encrypted data may be stored in a decentralized encrypted data storage network that is connected to the cryptocurrency network, allowing the service provider and lawful entity to act as participants in a subpoena and data retrieval process that is automated, as opposed to actors in a centralized service.

### PATENT CITATIONS

| Ref. | Cited Patent | Filing date | Pub. date | Applicant | Title |
|---|---|---|---|---|---|
| 1 | U.S. Pat. No. | Nov. 30, | Aug. 31, | Microsoft Corporation | Using hierarchical identity |
| | 7,788,484 B2 | 2005 | 2010 | | based cryptography for |
| | | | | | authenticating outbound mail |
| 2 | U.S. Pat. No. | Aug. 13, | Sep. 26, | The Board Of Trustees | Systems and methods for identity- |
| | 7,113,594 B2 | 2002 | 2006 | Of The Leland Stanford | based encryption and related |
| | | | | University, University | cryptographic techniques |
| | | | | Of California Davis | |
| 3 | WO2002051066 | Dec. 14, | Jun. 27, | Gchq, Clifford | Directory less public key |
| | A1 | 2001 | 2002 | Christopher Cocks | cryptographic system and method |

What is claimed is:

1. A method for uniquely identifying an individual comprising:
providing personal information for an individual;
using an element or plurality of elements of provided personal information as an input to a cryptographic hash function or a plurality of cryptographic hash functions;
identifying standard identification numbers at a subdivision, national, and international level;
using the digest of the cryptographic hash function or plurality of cryptographic hash functions to create an identity hash, where this hash uniquely identifies an individual within a subdivision, nation, or globally if a standard identification number is used as an input, while leaving the identity hash cryptographically impractical to reverse and the individual's provided personal information secure;
associating public geographic identifiers with the identity hash that reveal the subdivision and Country associated with the identity hash;
associating a compliance level code with an identity hash that reveals the level of verification associated with any documentary or non-documentary identity verification procedure, and if a standard identification number was used and the identity hash is unique to a subdivision, nation, or is globally unique;
associating an ID type indicator with the identity hash that reveals the type of identification that was used alone or with a plurality of other elements, salt, and other data to create the identity hash, also indicating if a standard identification number was used and the identity hash is unique to a subdivision, nation, or is globally unique;
associating other identifying data or metadata to the identity hash;
creating an identity signature for an individual comprising: the identity hash, or a concatenation of the identity hash and any or all of the geographic indicator, compliance level code, ID type indicator, or other identifying data or metadata;
associating the identity signature with a cryptocurrency address or plurality of cryptocurrency addresses by sending a digitally signed transaction to the address or plurality of addresses, or by digitally signing a transaction sent from the address or plurality of addresses where the transaction contains the identity signature and the digital signature is provided by an authorized service provider who created the identity signature and optionally the documentary or non-documentary identity verification procedure directly, through a lawful agency, or through the use of an authorized vendor.

2. The method of claim 1, further applying a non-documentary or documentary identity verification procedure to provided personal information in order to suitably validate the identity of the individual if required by governing regulation.

3. The method of claim 1, using random or non-random data to be used as salt with an element or plurality of elements of provided personal information before entering information into a cryptographic hash function or plurality of cryptographic hash functions.

4. The method of claim 1, including provided or other data such as a passphrase, biometric identifiers, financial, or contact information with an element or plurality of elements of provided personal information before entering information into a cryptographic hash function or plurality of cryptographic hash functions.

5. The method of claim 1, automating settlement of any fees associated with the method for uniquely identifying an individual by including fees in the transaction or plurality of transactions containing the identity signature so as to compensate the ID verification service provider for the ID verification service, potentially as an output within a transaction or plurality of transactions depending on the underlying cryptocurrency protocol.

6. The method of claim 1, associating the identity signature with a stealth or routing cryptocurrency address or plurality of stealth or routing cryptocurrency addresses by sending a digitally signed transaction to the stealth or routing address or plurality of stealth or routing addresses, or by digitally signing a transaction sent from the stealth or routing address or plurality of stealth or routing addresses where the transaction contains the identity signature and the digital signature is provided by an authorized service provider who created the identity signature and optionally the documentary or non-documentary identity verification procedure directly, through a lawful agency, or through the use of an authorized vendor.

7. The method of claim 6, allowing regulations limiting the count or aggregate amount of transactions associated with a stealth or routing cryptocurrency address or Plurality of stealth or routing cryptocurrency addresses by sending a transaction or plurality of transactions to the stealth or routing cryptocurrency address or plurality of stealth or routing cryptocurrency addresses containing an identity signature along with count and amount metadata from private addresses derived from the stealth or routing cryptocurrency address or plurality of stealth or routing cryptocurrency addresses, leaving the participant's transaction history private through child addresses, while allowing compliant transactions going forward by referencing the count and amount metadata visible on the stealth or master address publicly.

8. A method for revoking an identification event comprising:
regenerating a the identity signature using a portion of the steps outlined in claim 1 and or methods of claim 1 or copying the identity signature directly;
replacing the existing compliance level code in the identity signature with a revocation code; or, if a compliance level code was not present in the identity signature, by concatenating a revocation code to the identity signature and thereby creating a revocation signature;
associating the revocation signature with the cryptocurrency address or plurality of cryptocurrency addresses previously associated with an identity signature by sending a digitally signed transaction to the address or plurality of addresses containing the revocation signature, or by digitally signing a transaction sent from the address or plurality of addresses containing the revocation signature where the digital signature is provided by an authorized service provider, through a lawful agency, or through the use of an authorized vendor.

9. The method of claim 8 automating settlement of any fees associated with the revocation event by including fees in the transaction or plurality of transactions containing the revocation signature so as to compensate the ID verification service provider for the revocation event, potentially as an output within a transaction or plurality of transactions depending on the underlying cryptocurrency protocol.

10. A method for validating the association of an identity with a cryptocurrency address or plurality of addresses comprising:
scanning for a transaction or plurality of transactions present on a cryptocurrency address or plurality of cryptocurrency addresses containing an identity signature;
verifying a transaction containing an identity signature is valid by comparing the digital signature of the service provider to the public key of the service provider and ensuring the difference between the timestamp of the transaction and the present time does not exceed any defined expiry period;
scanning for a transaction or plurality of transactions present on a cryptocurrency address or plurality of cryptocurrency addresses containing a revocation signature with a timestamp later than any transactions containing a corresponding identity signature;
verifying a transaction or plurality of transactions containing a revocation signature invalidates the identity verification of a previously verified cryptocurrency address or plurality of addresses by comparing the digital signature of the service provider to the public key of the service provider and confirming the timestamp associated with the revocation signature or plurality of revocation signatures is later than the timestamp associated with the identity signature or plurality of identity signatures.

11. A method of claim 10 for authorizing or denying a transaction or plurality of transactions with a verified cryptocurrency address or plurality of addresses comprising:
scanning for a transaction or plurality of transactions present on a verified cryptocurrency address or plurality of verified cryptocurrency addresses for subsequent transactions containing a matching identity signature;
counting the number of such transactions, or amount of principal in such transactions over variable periods of time;
denying, authorizing, or requiring additional levels of identity verification or information disclosure based on these amounts or counts if required by regulation.

12. A method of claim 10 for authorizing or denying a transaction or plurality of transactions with a verified cryptocurrency address or plurality of verified cryptocurrency addresses comprising:
scanning for the identity signature present on a transaction or plurality of transactions on a verified cryptocurrency address or plurality of addresses;
scanning for a geographic indicator, ID type indicator, or compliance level code within the identity signature;
authorizing, denying, or requiring additional levels of identity verification or information disclosure based on the Country and subdivision, compliance level code, or ID type indicator associated with the verified cryptocurrency address or plurality of verified cryptocurrency addresses.

13. A method for associating a verified cryptocurrency address or plurality of addresses containing an identity verification transaction and identity signature or plurality of such transactions and signatures with an encrypted personal information profile.

14. A method of claim 13 where an encrypted personal information profile is stored in a locally hosted or cloud hosted database.

15. A method of claim 13 where an encrypted personal information profile is stored in a stored on a decentralized encrypted network.

16. A method of claim 13 where a participant may read or modify the encrypted personal information by producing the access controls and or corresponding private keys for the verified cryptocurrency address or plurality of addresses if allowed by applicable regulation.

17. A method of claims 15 and 16 where a participant may retrieve their encrypted personal information by requesting it from a decentralized network using their identity signature, cryptocurrency address, or corresponding public key with a digital signature generated using the private key to their cryptocurrency address, and decrypting this information with their private key.

18. A method of claim 13 where a lawful entity may access encrypted personal information by producing a valid private key or access controls, or by serving a lawful order to the service provider.

19. A method of claims 1, 8, 10 and 13 where an application of these methods for any purpose requiring the identification of an individual in a decentralized system, especially applications satisfying regulation requiring individual identification and data retention as a requisite for performing financial activities.
